(19) United States
(12) Patent Application Publication
(10) Pub. No.: US 2023/0409958 A1
(43) Pub. Date: Dec. 21, 2023

(54) METHODS FOR TRANSFORMING CATEGORICAL SOURCE DATA DISTRIBUTIONS INTO TARGET DATA DISTRIBUTIONS FOR USE BY MACHINE LEARNING MODEL TRAINING

(71) Applicant: Oracle International Corporation, Redwood City, CA (US)

(72) Inventor: Robert James Oberbreckling, Boulder, CO (US)

(21) Appl. No.: 17/807,602

(22) Filed: Jun. 17, 2022

(51) Int. Cl. G06N 20/00; G06K 9/62

(52) U.S. Cl. CPC G06N 20/00; G06K 9/6257; G06K 9/6298

(57) ABSTRACT

Techniques for optimizing the sampling of both the highest resource source category and lower resource source categories of a given categorical source data set with an initial distribution such that a target distribution of the given categorical source data set may be reached are described. Data items of the respective categories may be indexed and sampled such that the number of data items that are sampled more than once are tracked. Sampling, according to the target distribution, may continue until stop criteria are satisfied. In some cases, the respective indexes are used to determine the moment at which the highest resource source category is fully sampled, therefore minimizing the number of duplicate data items and optimizing the use of the respective categories of data items. The target distribution may then be used to train a machine learning model.

### BACKGROUND

Procedures for training a machine learning model may include the use of one or more training data sets comprising categorical data. Preparing the training data sets themselves is a much-studied process, as proper application of training data sets in machine learning model training may lead to a more well-rounded machine learning model.

Training data sets may be prepared by sampling categorical data from a source distribution to a target distribution, wherein the target distribution may then be applied as a training data set to the machine learning model. When preparing training data sets, it may be advantageous to make use of as much of the data items within the training data set as possible, since this may provide the machine learning model with an optimum number of representative examples to learn from. However, a common dilemma that exists is knowing how much of the source data set to sample. For example, it may be advantageous to limit the amount of duplicate data items that are sampled from the source distribution to the target distribution since an uncontrolled number of duplicate data items may lead to an artificial bias and/or pattern of the target distribution. Some pre-existing solutions may include sampling the source distribution only until the first time at which a data item of the source distribution would be sampled again (e.g., for a second time), also known as sampling without replacement. However, sampling without replacement may lead to a lack of leverage of the highest resource category of the source distribution. In such scenarios, a lower resource category of the source distribution is fully sampled before the highest resource category is fully sampled, which may lead to an under-sampled version of the highest resource category.

### SUMMARY

Techniques for preparing a target distribution of a categorical source data set with an initial, source distribution are disclosed. Indexes and counters are used to randomly sample the data set and track the number of duplicate data items that are sampled. Sampling may stop when the system determines that the target distribution has been reached. The target distribution may then be used to train a machine language model.

### BRIEF DESCRIPTION OF THE DRAWINGS

FIG. 1 illustrates a given machine learning workflow in which a machine learning model is trained via generation of a target training data set, according to some embodiments.

FIG. 2 illustrates a given machine learning system configured to generate a target training data set and train a machine learning model, according to some embodiments.

FIG. 3 illustrates a given sequence of how a machine learning system may generate a target training data set by sampling a source training data set, according to some embodiments.

FIG. 4 illustrates a process of generating a target training data set by sampling a source training data set until one or more stop criteria have been met, according to some embodiments.

FIG. 5 illustrates a process of reshuffling an index corresponding to a respective category of data within the source training data set, according to some embodiments.

FIG. 6 illustrates a process of re-sampling the source training data set due to the addition of one or more data items to the source training data set, according to some embodiments.

FIG. 7 illustrates an example computing system, according to some embodiments.

While the disclosure is described herein by way of example for several embodiments and illustrative drawings, those skilled in the art will recognize that the disclosure is not limited to embodiments or drawings described. It should be understood that the drawings and detailed description hereto are not intended to limit the disclosure to the particular form disclosed, but on the contrary, the disclosure is to cover all modifications, equivalents and alternatives falling within the spirit and scope as defined by the appended claims. Any headings used herein are for organizational purposes only and are not meant to limit the scope of the description or the claims. As used herein, the word “may” is used in a permissive sense (e.g., meaning having the potential to) rather than the mandatory sense (e.g. meaning must). Similarly, the words “include”, “including”, and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. § 112(f) interpretation for that unit/circuit/component.

This specification includes references to “one embodiment” or “an embodiment.” The appearances of the phrases “in one embodiment” or “in an embodiment” do not necessarily refer to the same embodiment, although embodiments that include any combination of the features are generally contemplated, unless expressly disclaimed herein. Particular features, structures, or characteristics may be combined in any suitable manner consistent with this disclosure.

### DETAILED DESCRIPTION OF EMBODIMENTS

Various techniques for sampling a source categorical data set with an initial, source distribution to a target categorical data set with a different, target distribution are described herein. Sampling the highest resource source category until the category is fully sampled allows the highest resource source category to be optimized by the machine learning model being trained by the given training data set. In some embodiments, it may be advantageous to maximize the use of the highest resource category of the source distribution, which may be sampled without replacement (e.g., sampled without duplicate data items), while minimizing the amount of sampling with replacement (e.g., sampled with duplicate data items) that inevitably may take place within the lower resource categories of the source distribution.

In the embodiments described herein, when a given category is “sampled with replacement,” this may refer to a first set of scenarios in which the given category has been sampled fully once, and in which one or more data items of the given category have additionally been sampled a second time (e.g., one or more data items are sampled twice total) or more. This first set of scenarios may also be referred to as “sampled with partial replacement.” However, “sampled with replacement” may additionally refer to a second set of scenarios in which the given category has been sampled fully once, and sampled fully again, etc. This second set of scenarios may be referred to as “sampled with full replacement.”

Also in the embodiments described herein, when a given category is “sampled without replacement,” this may refer to a first set of scenarios in which the given category has been fully sampled once and no data items have been additionally sampled a second (third, fourth, etc.) time. This first set of scenarios may also be referred to as “fully sampled without replacement.” However, “sampled without replacement” may additionally refer to a second set of scenarios in which the given category comprises no duplicate data items but also has not been fully sampled. This second set of scenarios may also be referred to as “partially sampled without replacement.”

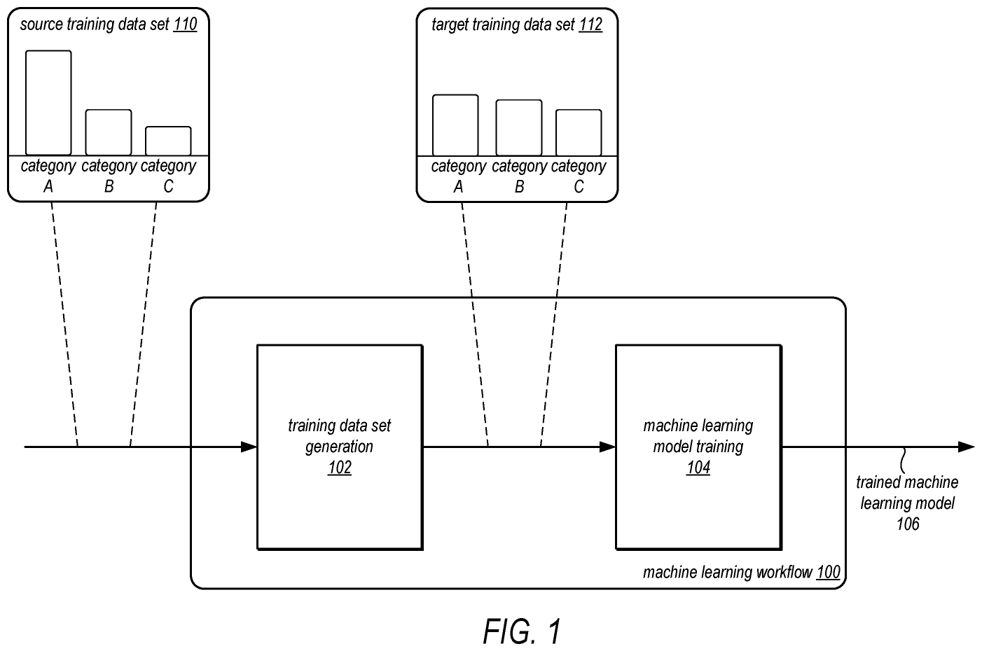

FIG. 1 illustrates a given machine learning workflow in which a machine learning model is trained via generation of a target training data set, according to some embodiments.

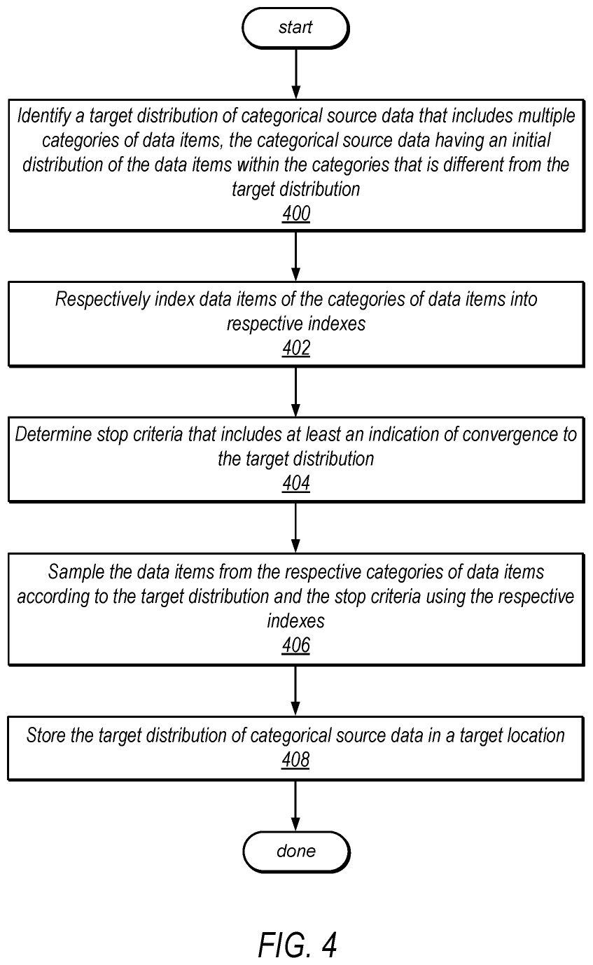

In some embodiments, machine learning workflow 100 may describe the process of generating a target training data set, such as target training data set 112, and using the target training data set for training a machine learning model. Target training data set 112 may be generated via training data set generation 102, which includes a process of sampling a given source training data set, such as source training data set 110, in order to achieve a target distribution of the source data items, such as target training data set 112. In some embodiments, FIGS. 4, 5, and 6 describe processes and implementations of training data set generation 102.

In some embodiments, a source training data set, such as source training data set 110, may include multiple categories of data items, also referred to as categorical data items. A data item may be defined as a base unit and/or piece of information (e.g., a letter, word, sentence, phrase, audio data, image data, video data, etc.) that may be received, utilized, treated, and/or stored via one or more computing devices, such as computer system 700, according to some embodiments. Such data items may be grouped and/or categorized into categories (e.g., categorization by language, demographic information, or another qualitative and/or conditional properties of data items within the given data set) in order to form a categorical data set. In some embodiments, a categorical data set may be defined by a respective categorical definition. In the example shown, source training data set 110 includes categories A, B, and C in which data items comprised within source training data set 110 may be divided up into, wherein category A has the largest amount of data items at the given moment captured by the example embodiments shown in FIG. 1. In the example embodiments shown for source training data set 110 in FIG. 1, category A may be referred to as being the highest resource source category. It may then follow that categories B and C, as shown for source training data set 110 in FIG. 1, may be referred to as being lower resource source categories, according to some embodiments. Additionally, source training data set 110 may be referred to as having an initial (e.g., unaltered, “raw,” etc.) distribution of data items.

Target training data set 112 may include data items that may also be found within source training data set 110 and may reflect a target distribution of the data items, as opposed to the source distribution of source training data set 110. In some embodiments, by nature of allowing the largest resource source category to be fully sampled, one or more of the lower resource source categories may sampled with replacement (or with partial replacement). In such embodiments, target training data set 112 may include a larger amount of data items than source training data set 110. In other embodiments, target training data set 112 may have a size threshold that is smaller than the size of source training data set 110.

In some embodiments, target training data set 112 may have a certain format and/or may reflect one or more design choices that may make target training data set 112 more adapted to training the given machine learning model, as opposed to an initial training data set such as source training data set 110. In some embodiments, it may be advantageous for the target distribution of the target training data set to be different from the source distribution of the source training data set. For example, a given target distribution may be corrected, transformed, manipulated, or converted with respect to the respective source distribution. In some embodiments, such transformations to the target distribution may refer to balancing an imbalanced source distribution, and/or unbalancing a balanced source distribution.

In an example embodiment of source training data set 110, source training data set 110 includes a given source distribution with three categories of categorical data items in which category A represents 50% of the total data items within source training data set 110, category B represents 30%, and category C represents 20%. A target distribution for a respective target training data set 112 derived from data items in source training data set 110 may then include that category A represents 35% of the total data items within target training data set 112, and that categories B and C represent 34% and 31%, respectively. A person having ordinary skill in the art should understand that source training data set 110 having three categories of categorical data items is meant to be an exemplary embodiment of source training data set 110, and that other embodiments of source training data set 110 may include more or less categories of categorical data items and/or different source distributions.

Target training data set 112 may then be used to train and/or build a given machine learning model (e.g., a natural language model, a speech recognition model, a multimodal model, etc.) in machine learning model training 104. In some embodiments, target training data set 112, in addition to one or more validation data sets and/or testing datasets, may be used to train a given machine learning model, wherein the validation and testing data sets may also be prepared using the processes described herein. In such embodiments, target training data set 112 may be used as part of at least one of the following steps: training the machine learning model, validating target functionalities of the machine learning model, and testing the given machine learning model for its responses pertaining to those target functionalities. Such steps may take place within machine learning model training 104, such that trained machine learning model 106 reflects the usage of at least target training data set 112.

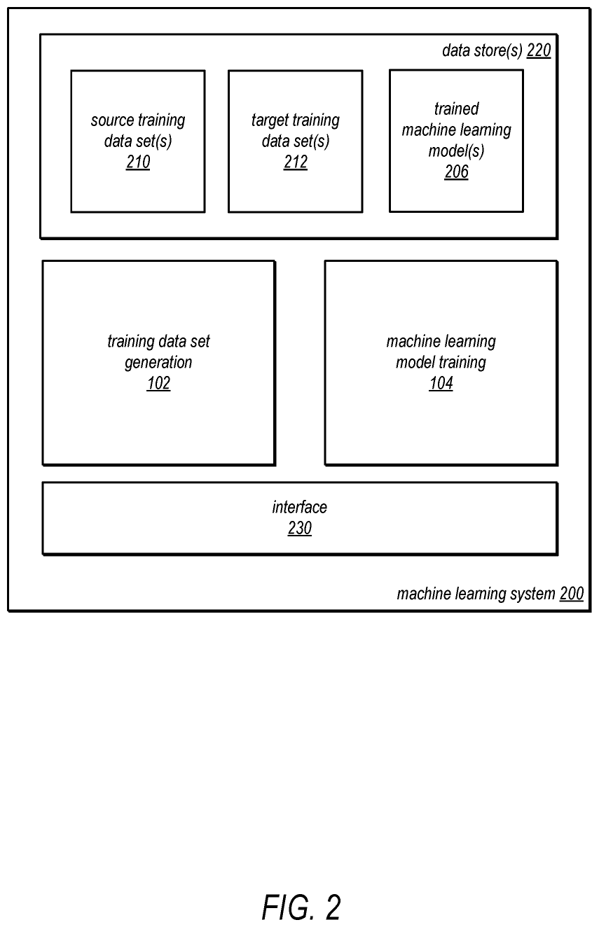

FIG. 2 illustrates a given machine learning system configured to generate a target training data set and train a machine learning model, according to some embodiments.

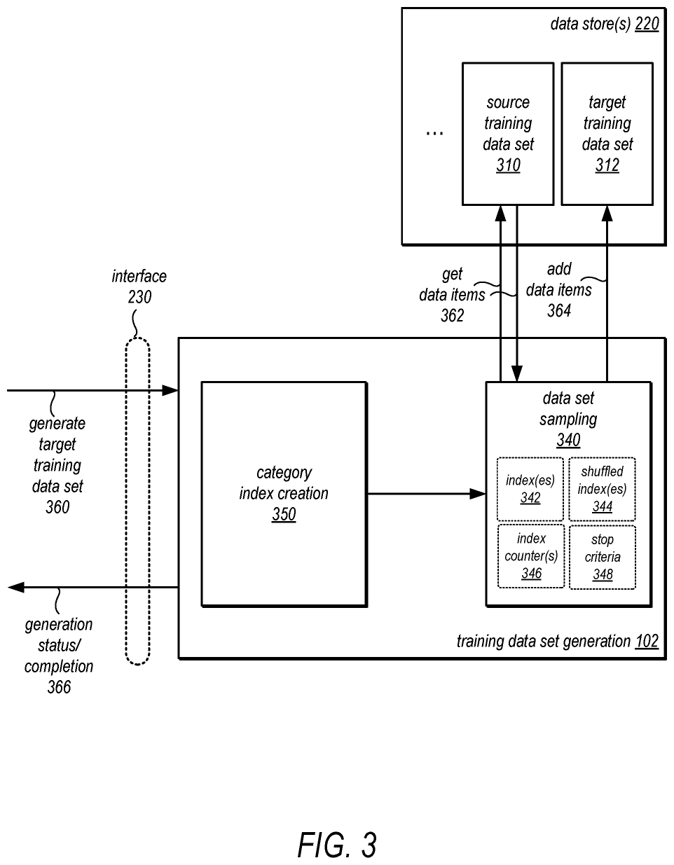

In some embodiments, a machine learning system, such as machine learning system 200, may include training data set generation 102, machine learning model training 104, data stores 220, and interface 230. In some embodiments, training data set generation 102 and machine learning model training 104 may resemble the embodiments and functionalities described in FIGS. 1 and 3.

In some embodiments, data stores 220 may include source training data set(s) 210, target training data set(s) 212, and trained machine learning model(s) 206. Source training data set(s) 210 may include source training data set 110, among other source training data sets including categories of data items. Target training data set(s) 212 may include target training data set 112, among other target training data sets including categories of data items.

In some embodiments, data stores 220 may be implemented as part of a data storage service of a provider network which may implement different types of data stores for storing, accessing, and managing data on behalf of clients of the data storage service as a network-based service that enables the clients to operate a data storage system in a cloud or network computing environment. For example, a centralized data store of the data storage service may be implemented such that other sections of the data storage service may access data stored in the centralized data store for processing and or storing within the other data storage services, in some embodiments. Such an implementation of data stores 220 within a data storage service may be implemented as an object-based data store, and may provide storage and access to various kinds of object or file data stores for putting, updating, and getting various types, sizes, or collections of data objects or files. Such data store implementations included within a data storage service may be accessed via programmatic interfaces (e.g., APIs) or graphical user interfaces. Such a data storage service may provide virtual block-based storage for maintaining data as part of data volumes that can be mounted or accessed similar to local block-based storage devices (e.g., hard disk drives, solid state drives, etc.) and may be accessed utilizing block-based data storage protocols or interfaces, such as internet small computer interface (iSCSI).

In some embodiments, interface 230 may be implemented as a graphical user interface. However, interface 230 may also be implemented as various types of programmatic (e.g., Application Programming Interfaces (APIs)) or command line interfaces to support the methods and systems described herein. Interface 230 may receive a given source training data set and provide a given target training data set, according to some embodiments. Additionally, in some embodiments, interface 230 may receive one or more data items after an initial source training data set has been submitted to interface 230.

Machine learning system 200 may be implemented as part of a service of a provider network (e.g., a cloud provider), such as a natural language training service, according to some embodiments. In some embodiments, machine learning system 200 may be implemented as a service of the same or different provider network as the data storage service discussed above.

FIG. 3 illustrates a given sequence of how a machine learning system may generate a target training data set by sampling a source training data set, according to some embodiments.

Generate target training data set 360 may be submitted via interface 230 and may, at least in part, trigger the workflow described in FIG. 1, according to some embodiments.

In some embodiments, category index creation 350 may describe the process of respectively indexing data items within respective categories of the given source training data set, such as source training data set 310 (see also block 402 described herein). For example, a given category comprising N data items within source training data set 310 may be indexed from zero to N−1. Such indexes may be stored within arrays corresponding to respective categories of source training data set 310. Such indexes may then be referenced in index(es) 342 and used during data set sampling 340. In some embodiments, it may be advantageous to reference arrays of indexes that correspond to data items within respective categories of source training data set 310 instead of referencing the data items directly since this may require the storage of potentially large data items within arrays and/or shuffling arrays that include large data items. Additionally, referencing arrays of indexes may reduce computational resources of the computing devices (e.g., computer system 700) utilized by machine learning system 200. It may also be advantageous to index the data items within the respective categories since, once the data items have been counted via the indexes, the number of duplicate data items that ultimately may get added to target training data set 312 may be deduced.

In some embodiments, prior to sampling a first data item from source training data set 310, index(es) 342 may be randomly shuffled and placed within shuffled index(es) 344. For example, in a given embodiment in which category A of source training data set 310 includes ten data items, category index creation 350 may result in index position zero referring to data item 1, index position one referring to data item 2, etc., and index position nine referring to data item 10. The respective initial index array within index(es) 342 may resemble [0, 1, 2, 3, 4, 5, 6, 7, 8, 9], according to some embodiments. Then, a randomly shuffled version of the initial index array, found within shuffled index(es) 344, may resemble [3, 6, 4, 5, 8, 1, 9, 2, 7], according to some embodiments. Such embodiments may allow the given category, such as category A in the described example, to be randomly sampled. Random sampling may be advantageous to the embodiments described herein since it may reduce artificially-made patterns within the target distribution caused by directly sampling source training data set 310 and/or by data items that may have been otherwise sampled more than once.

In addition, it may be advantageous to use arrays of indexes, such as arrays of indexes described in the embodiments above, since this may allow both the largest resource source category and the one or more lower resource source categories to be fully sampled without replacement prior to continuing to sample one or more of the lower resource source categories, which may ensure an efficient use of data items within the lower resource source categories (e.g., reducing the number of data items that are sampled more than once from the lower resource source categories). One or more of the lower resource source categories may then continue to be sampled (e.g., sampled with replacement). However, fully sampling the lower resource source categories first without replacement before resulting to sampling with replacement ensures that target training data set 312 includes optimal usage of the lower resource source categories, according to some embodiments.

In some embodiments, stop criteria 348 may include one or more stop criteria that may be used to indicate that sampling may be stopped, once (all) stop criteria in stop criteria 348 have been satisfied. In some embodiments, stop criteria 348 may include an indication and/or measure of convergence of a source distribution to a given target distribution A person having ordinary skill in the art should understand that convergence to a target distribution may refer to convergence, within a given threshold, to a target distribution. For example, an indication and/or measure of convergence for category A of source training data set 110 may be when category A reaches, and/or is within a given threshold of, 35% of the total data items within target training data set 112. Stop criteria 348 may additionally include an indication that the largest resource source category of a given source training data set has been fully sampled without replacement, according to some embodiments. Other embodiments of stop criteria in stop criteria 348 may include an indication that the target data set (e.g., target training data set 312) has reached a given size limit. A person having ordinary skill in the art should understand that the examples provided for stop criteria 348 are not meant to be exhaustive, and that stop criteria 348 may additionally include combinations of at least the examples of stop criteria described herein. In addition, in some embodiments in which one of the stop criterion of the stop criteria have been met but at least one other stop criterion of the stop criteria have not been met, sampling may continue until each stop criterion of the stop criteria are met. For example, in some embodiments in which there are two stop criteria, such as an indication of convergence of the source distribution to the target distribution and an indication that the largest resource source category has been fully sampled without replacement, the stop criterion pertaining to convergence to the target distribution may occur before the largest resource source category has been fully sampled without replacement. In such embodiments, sampling may continue until the largest resource source category has been fully sampled without replacement, at which point sampling may be stopped.

Stop criteria 348 may be used to determine, at least in part, when to stop sampling a given source training data set. In such embodiments, during sampling of data items from respective categories within source training data set 310, one or more non-transitory, computer-readable storage media storing program instructions may cause one or more computing devices (e.g., computer system 700) to determine that the given stop criteria have been satisfied. Stop criteria 348 may also include different stop criteria that may be associated to respective source training data sets stored in data store(s) 220, according to some embodiments.

In some embodiments, during the process of sampling source training data set 310 via data set sampling 340, one or more data items may be retrieved from source training data set 310 using get data items step 362. For example, continuing the example embodiment described above in which a given category of source training data set 310 includes ten data items that are indexed from zero to nine and with the indexes randomly shuffled into an index array such as [3, 6, 4, 5, 8, 1, 9, 2, 7], data set sampling 340 may request the data item corresponding to index position 3 within the given index array (e.g., wherein index position 3 corresponds to data item 4 according to the above example embodiment description). Data item 3 may then be retrieved from data store(s) 220 via get data items 362 and stored, via add data items 364, into target training data set 312 according to the target distribution and the stop criteria. Such a process may repeat until the one or more stop criteria have been satisfied, according to some embodiments. In some embodiments, one or more data items may be sampled at a given time, and/or from one or more respective categories within source training data set 310.

In some embodiments, after a given data item has been requested and then stored into target training data set 312, data set sampling 340 may refer to stop criteria 346 to confirm if the stop criteria have been satisfied or not (see also the description for block 508 herein).

In some embodiments, after a given index position has been requested, an index counter corresponding to the given category may be incremented. Such respective index counters may be referenced in index counter(s) 346. In some embodiments, prior to sampling a first data item from source training data set 310, index counter(s) 346 may be initialized to zero. Continuing the above example embodiment, data set sampling 340 may request the data item corresponding to index position 3, and this may cause the respective index counter within index counter(s) 346 to be incremented. In some embodiments, index counter(s) 346 may be used to determine when a given category has been fully sampled. Continuing the above example embodiment, after data set sampling 340 has requested the data item corresponding to index position 7 and stored the data item in target training data set 312, the respective index counter may be incremented to nine, and data set sampling 340 may then confirm that the given category has been fully sampled. In embodiments in which the given category is not associated to triggering stop criteria 348 (e.g., determining that stop criteria 348 have been satisfied), this may cause data set sampling 340 to re-shuffle the given shuffled index array within shuffled index(es) 344 and/or to re-initialize the respective index counter within index counter(s) 346 to zero, and data set sampling 340 may continue to sample from source training data set 310. In embodiments in which the given category is associated to triggering stop criteria 348, data set sampling 340 may stop sampling from source training data set 310.

In some embodiments, after determining that stop criteria 348 have been satisfied, target training data set 312 may be stored in a target location such as data store(s) 220 and generation status/completion 366 may be provided via interface 230.

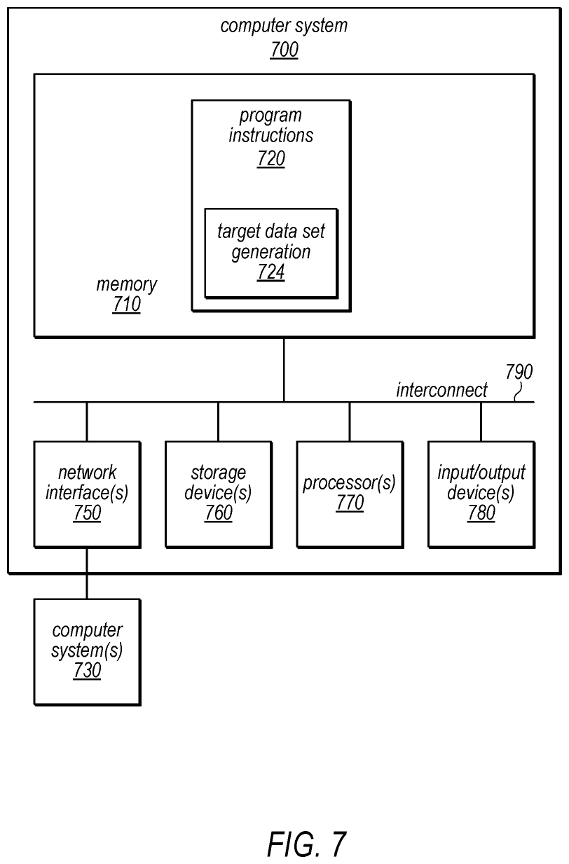

Various different systems, services, or applications may implement the techniques discussed above. For example, FIG. 7, discussed below, provides an example computing system that may implement various ones of the techniques discussed above. FIGS. 4, 5, and 6, also discussed below, are flow diagrams illustrating methods and techniques for generating a target training data set, according to some embodiments, which may be performed by different systems, services, or applications.

FIG. 4 illustrates a process of generating a target training data set by sampling a source training data set until one or more stop criteria have been met, according to some embodiments.

In some embodiments, a target distribution of categorical source data is identified in block 400. Continuing the example embodiment described above in which a given source training data set comprising categories A, B, and C with a given source distribution of 50%, 30%, and 20%, respectively, the target distribution may be different from the source distribution (e.g., 35%, 34%, and 31%, respectively).

In block 402, data items of the categorical source data are indexed into respective indexes by category, according to some embodiments. In some embodiments, block 402 may refer to category index creation 350, and source training data set 310 may be indexed and placed into index(es) 342. The indexes described in block 402 may also be shuffled and placed into shuffled index(es) 344, according to some embodiments. In addition, in block 404, stop criteria for generating the target distribution are determined, according to some embodiments. Such stop criteria may refer to stop criteria 348 and the functionalities and embodiments used to describe stop criteria 348. In some embodiments, the stop criteria may include an indication and/or measure of convergence to the target distribution (e.g., within a given threshold). The stop criteria may additionally include an indication that the largest category of data items of the categories of data items introduced in block 400 has been fully sampled.

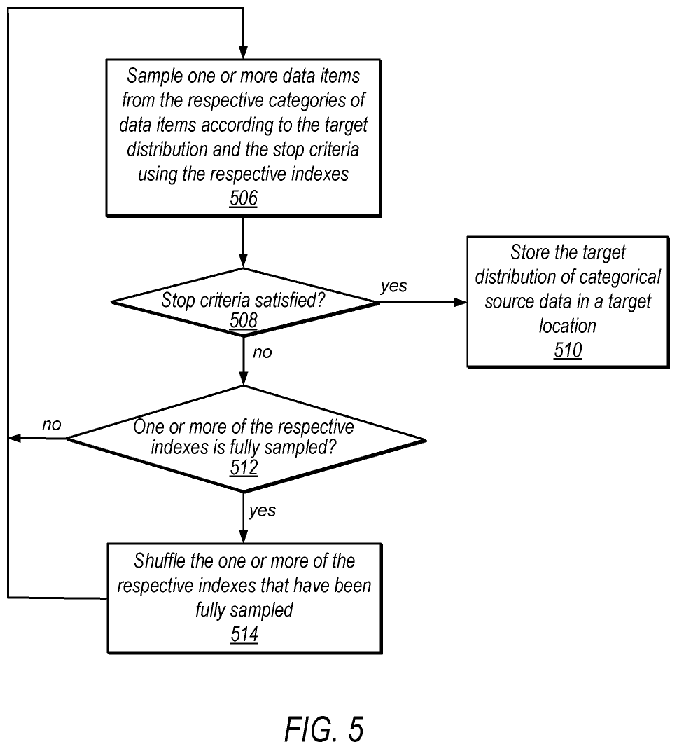

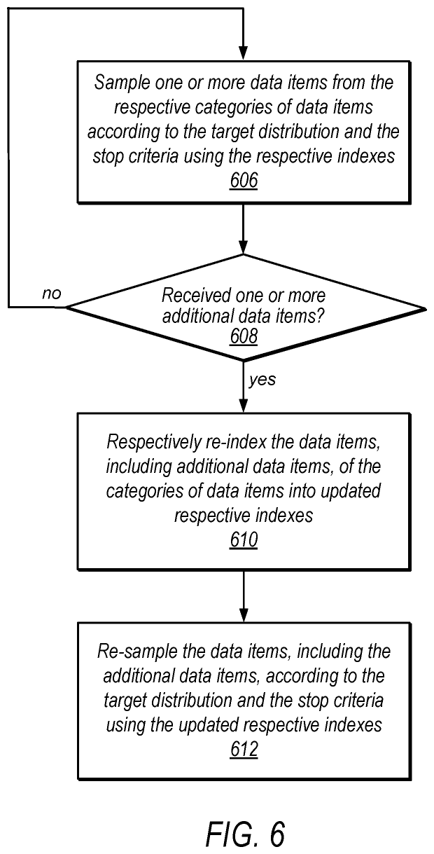

In some embodiments, data items from respective categories of the categorical source data are sampled according to both the target distribution and the stop criteria in block 406. In some embodiments, block 406 may resemble the processes described in FIG. 3, wherein data set sampling 340 may retrieve data items from source training data set 310 and store the data items into target training data set 312, according to some embodiments. Block 406 may additionally refer to the use of stop criteria 348. In some embodiments, the sampling in block 406 may further include the processes described by the flowcharts in FIGS. 5 and 6.

In block 408, the target distribution of categorical source data is stored in a target location. In some embodiments, the target location may be a data store of the machine language system, such as data store 220.

FIG. 5 illustrates a process of reshuffling an index corresponding to a respective category of data within the source training data set, according to some embodiments.

In block 506, one or more data items from respective categories of the categorical source data are sampled according to the both the target distribution and the stop criteria, according to some embodiments. In some embodiments, block 506 may refer to embodiments and functionalities described for block 406 and for the processes described for FIG. 3.

In some embodiments, after a given one or more data items from the source training data set, such as source training data set 310, have been sampled, a check may be performed to confirm if the stop criteria have been satisfied, as indicated at block 508. If the stop criteria have been satisfied, then the target distribution of categorical source data are stored in a target location in block 510. In some embodiments, block 510 may describe a process in which target training data set 312 is stored in a target location, such as data store(s) 220. If the stop criteria have not been satisfied, then it may be determined if one or more of the respective index arrays has been fully sampled or not, as indicated at block 512. If one or more of the respective index arrays have been fully sampled, then the respective one or more index arrays may be re-shuffled in block 514. If one or more of the respective index arrays have not been fully sampled, then machine learning system 200 continues to sample one or more data items as described in block 506.

In some embodiments in which the stop criteria checked at block 508 include determining that the index corresponding to the largest resource source category has been fully sampled without replacement, that the stop criteria may have been satisfied, and follow the process described by block 510. Additionally in these given embodiments, recognition that an end to sampling was not triggered (e.g., at block 510), then the one or more respective indexes that may be fully sampled at block 512 may not include the index corresponding to the largest resource source category by default.

FIG. 6 illustrates a process of re-sampling the source training data set due to the addition of one or more data items to the source training data set, according to some embodiments.

In some embodiments, one or more data items may be added to source training data set 310 after data set sampling 340 has already begun sampling from source training data set 310 and before data set sampling 340 stops sampling from source training data set 310. In such embodiments, source training data set 310 may be referred to as an “open” source data set, as opposed to a “closed” source data set (e.g., embodiments in which source training data set 310 may not receive one or more additional data items for the duration that data set sampling 340 samples from source training data set 310.)

As shown in FIG. 6, block 606 refers to sampling one or more data items from the respective categories of data items according to the target distribution and the stop criteria using the respective indexes. During the first iteration of the embodiments shown in FIG. 6, one or more data items from source training data set 310 may be sampled, marking the beginning of data set sampling 340's sampling from source training data set 310. In block 608, a check for the reception of one or more additional data items (e.g., one or more data items that were not included within source training data set 310 at the moment of the first iteration through block 606) is made. If it is determined that no additional data items have been received, as indicated by the negative exit from block 608, then machine learning system 200 continues to sample source training data set 310 according to block 606 (e.g., in a second and/or one or more additional iterations) and the embodiments shown in FIGS. 4 and 5.

However, if it is determined that one or more additional data items have been received, then the data items of source training data set 310, which now include the one or more additional data items, are re-indexed into updated respective indexes, as indicated at block 612. In some embodiments, the one or more additional data items may fall within the same or different categories of source training data set 310.

In some embodiments, the one or more additional data items may be received via interface 230 and subsequently stored within source training data set 310 within data store(s) 220, according to the embodiments shown in FIG. 3. The reception of the one or more additional data items may also trigger category index creation 350, according to some embodiments. Data set sampling 340 may then re-index the data items in source training data set 310 into respective index arrays by category and place the updated indexes into index(es) 342, and index(es) 342 may be randomly shuffled and placed within shuffled index(es) 344, according to some embodiments. Index counter(s) 346 may also be re-initialized to zero.

Once machine learning system 200 has accounted for the one or more additional data items via the methods described by the preceding paragraphs, the data items (e.g., the original data items included within source training data set 310 and the one or more additional data items) may be re-sampled according to the target distribution and the stop criteria using the updated respective index arrays. Such re-sampling may refer to the processes and methods described for FIGS. 4 and 5, according to some embodiments.

The reception of the one or more additional data items may also cause stop criteria 348 to be updated, according to some embodiments. For example, in embodiments in which stop criteria 348 may include an indication that the largest resource source category of a given source training data set has been fully sampled without replacement, machine learning system 200 may verify that, after the addition of the one or more data items, the largest resource source category remains the same as the largest resource source category determined prior to the addition of the one or more additional data items.

In some embodiments, the criteria of the target distribution may change after data set sampling 340 has already begun sampling from source training data set 310 and before data set sampling 340 stops sampling from source training data set 310. In response to receiving an indication that the target distribution has been updated, stop criteria 348 may be subsequently updated, such that stop criteria 348 include an indication of convergence to the updated target distribution. In such embodiments, sampling, such as the sampling described in the embodiments shown in FIGS. 4 and 5, would take place according to the updated target distribution and the updated stop criteria, according to some embodiments.

In addition to the embodiments described for FIG. 6 herein in reference to an open source data set, additional embodiments of an open source data set may exist which may pertain to streaming. In some embodiments, machine learning system 200 may turn off and on a streaming function. Streaming may refer to a type of open source data set in which additional data items are received near-continuously, periodically, frequently, and/or in a large volume such that it may be advantageous to maintain a continuous form of sampling of source training data set 310, according to some embodiments.

In such streaming embodiments, the streaming function may be turned on, and additional data items for at least one category of data items included within source training data set 310 may be received via interface 230 to machine learning system 200. The additional data items may be added to the pre-existing source training data set 310 using data store(s) 220. Additionally, an overwrite criteria may be added to stop criteria 348, wherein the overwrite criteria launches a continuation of the sampling (e.g., after the stop criteria have been satisfied). In some embodiments, the overwrite criteria may refer to effectively removing the connection between the stop criteria being satisfied and stopping the sampling of source training data set 310 (e.g., block 508 and block 510). In such embodiments, when block 508 determines that the stop criteria have been satisfied, sampling continues, and, in the embodiments shown in FIG. 5, block 512 is next used to determine the next step in the sampling process.

In such streaming embodiments, if the streaming function is turned on, machine learning system 200 may continue to sample from source training data set 310 according to the target distribution and the original stop criteria within stop criteria 348. Block 508 may continue to determine if the original stop criteria have been satisfied. If the original stop criteria have not been satisfied, machine learning system 200 may continue to sample from source training data set 310 and/or receive additional data items to source training data set 310 according to the embodiments shown in FIGS. 4 and 5. If, however, a flag to machine learning system 200 marks that the original stop criteria have been satisfied, then the overwrite criteria may be used to launch a continuation of the sampling, according to some embodiments. In such embodiments, sampling may continue after the overwrite criteria is triggered, and machine learning system may continue to use the original stop criteria to work towards convergence to the target distribution in a cyclical manner.

Additionally, machine learning system 200 may turn the streaming function off, according to some embodiments. In such embodiments, turning the streaming function off may cause the overwrite criteria to be removed from stop criteria 348, and sampling of source training data set 310 may continue until the updated (e.g., stop criteria 348 without the overwrite criteria) stop criteria are satisfied.

A person having ordinary skill in the art should understand that the various embodiments described herein pertaining to both closed and open data sets may be used separately, together, and in conjunction with one another. For example, an initial source training data set may be received to machine learning system 200 and may be perceived as a closed data set by default. Then at a given moment during sampling of the given initial source training data set, one or more data items may be received, allowing the source training data set to be perceived as an open data set. This may trigger the embodiments described in FIG. 5, according to some embodiments. In embodiments in which the streaming function is turned on, the overwrite criteria may be added, as described above. In some further embodiments, the streaming function is turned back off at a later moment, and source training data set may once again be perceived as a closed data set, according to some embodiments.

FIG. 7 illustrates an example computing system, according to some embodiments.

FIG. 7 illustrates a computing system configured to implement the methods and techniques described herein, according to various embodiments. The computer system 700 may be any of various types of devices, including, but not limited to, a personal computer system, desktop computer, laptop or notebook computer, mainframe computer system, handheld computer, workstation, network computer, a consumer device, application server, storage device, a peripheral device such as a switch, modem, router, etc., or in general any type of computing device.

The mechanisms for implementing online post-processing in rankings for constrained utility maximization, as described herein, may be provided as a computer program product, or software, that may include a non-transitory, computer-readable storage medium having stored thereon instructions, which may be used to program a computer system (or other electronic devices) to perform a process according to various embodiments. A non-transitory, computer-readable storage medium may include any mechanism for storing information in a form (e.g., software, processing application) readable by a machine (e.g., a computer). The machine-readable storage medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; electrical, or other types of medium suitable for storing program instructions. In addition, program instructions may be communicated using optical, acoustical or other form of propagated signal (e.g., carrier waves, infrared signals, digital signals, etc.)

In various embodiments, computer system 700 may include one or more processors 770; each may include multiple cores, any of which may be single or multi-threaded. Each of the processors 770 may include a hierarchy of caches, in various embodiments. The computer system 700 may also include one or more persistent storage devices 760 (e.g. optical storage, magnetic storage, hard drive, tape drive, solid state memory, etc.) and one or more system memories 710 (e.g., one or more of cache, SRAM, DRAM, RDRAM, EDO RAM, DDR 10 RAM, SDRAM, Rambus RAM, EEPROM, etc.). Various embodiments may include fewer or additional components not illustrated in FIG. 7 (e.g., video cards, audio cards, additional network interfaces, peripheral devices, a network interface such as an ATM interface, an Ethernet interface, a Frame Relay interface, etc.)

The one or more processors 770, the storage device(s) 760, and the system memory 710 may be coupled to the system interconnect 790. One or more of the system memories 710 may contain program instructions 720. Program instructions 720 may be executable to implement various features described above, including a target data set generation 724 discussed above with regard to FIGS. 1, 2, and 3 that may perform the various training and application of models, in some embodiments as described herein. Program instructions 720 may be encoded in platform native binary, any interpreted language such as Java™ byte-code, or in any other language such as C/C++, Java™, etc. or in any combination thereof.

In one embodiment, Interconnect 790 may coordinate I/O traffic between processors 770, storage devices 760, and any peripheral devices in the device, including network interfaces 750 or other peripheral interfaces, such as input/output devices 780. In some embodiments, Interconnect 790 may perform any necessary protocol, timing or other data transformations to convert data signals from one component (e.g., system memory 710) into a format suitable for use by another component (e.g., processor 770). In some embodiments, Interconnect 790 may include support for devices attached through various types of peripheral buses, such as a variant of the Peripheral Component Interconnect (PCI) bus standard or the Universal Serial Bus (USB) standard, for example. In some embodiments, the function of Interconnect 790 may be split into two or more separate components, such as a north bridge and a south bridge, for example. In addition, in some embodiments some or all of the functionality of Interconnect 790, such as an interface to system memory 710, may be incorporated directly into processor(s) 770.

Network interface 750 may allow data to be exchanged between computer system 700 and other devices attached to a network, such as other computer systems, or between nodes of computer system 700. In various embodiments, network interface 750 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 780 may, in some embodiments, include one or more display terminals, keyboards, keypads, touchpads, scanning devices, voice or optical recognition devices, or any other devices suitable for entering or retrieving data by one or more computer system 700. Multiple input/output devices 780 may be present in computer system 700 or may be distributed on various nodes of computer system 700. In some embodiments, similar input/output devices may be separate from computer system 700 and may interact with one or more nodes of computer system 700 through a wired or wireless connection, such as over network interface 750.

Those skilled in the art will appreciate that computer system 700 is merely illustrative and is not intended to limit the scope of the methods for providing enhanced accountability and trust in distributed ledgers as described herein. In particular, the computer system and devices may include any combination of hardware or software that may perform the indicated functions, including computers, network devices, internet appliances, PDAs, wireless phones, pagers, etc. Computer system 700 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 700 may be transmitted to computer system 700 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed:

1. A system, comprising:
categorical source data comprising a plurality of categories of data items, wherein the categorical source data has an initial distribution of data items within the plurality of categories;
a machine learning system, wherein the machine learning system configured to:
identify a target distribution of the categorical source data, wherein the target distribution is different from the initial distribution;
respectively index the data items of the plurality of categories into respective indexes;
determine stop criteria, wherein the stop criteria comprise at least an indication of convergence to the target distribution;
sample the data items from the respective categories of data items according to the target distribution and the stop criteria using the respective indexes, wherein the sample the data items comprises:
determining that at least one index of the respective indexes has been fully sampled;
shuffling the at least one index; and
determining that the stop criteria have been satisfied; and
store the target distribution of the categorical source data in a target location.

2. The system of claim 1, wherein the machine learning system is implemented as part of a service offered by a provider network.

3. The system of claim 2, wherein the machine learning system is further configured to provide the target distribution of the categorical source data for use by a natural language training service of the provider network.

4. The system of claim 1, wherein the machine learning system is further configured to:
receive additional data items to at least one of the categories of the plurality of categories of data items;
add the additional data items to the data items being sampled;
add overwrite criteria to the stop criteria, wherein the overwrite criteria causes a continuation of the sampling; and
in response to the determining that the stop criteria have been satisfied, continue the sampling.

5. The system of claim 4, wherein the machine learning system is further configured to remove the overwrite criteria from the stop criteria.

6. A method, comprising:
identifying, by a machine learning system, a target distribution of categorical source data comprising a plurality of categories of data items, wherein:
the categorical source data has an initial distribution of the data items within the plurality of categories; and
the target distribution is different from the initial distribution;
respectively indexing, by the machine learning system, data items of the plurality of categories of data items into respective indexes;
determining, by the machine learning system, stop criteria for generating the target distribution;
sampling, by the machine learning system, the data items from the respective categories of data items according to the target distribution and the stop criteria using the respective indexes;
determining that the stop criteria have been satisfied; and
storing, by the machine learning system, the target distribution of categorical source data in a target location.

7. The method of claim 6, the method further comprising:
responsive to respectively indexing, by the machine learning system, the data items of the plurality of categories of data items into the respective indexes,
shuffling the respective indexes.

8. The method of claim 6, the method further comprising:
responsive to determining that the stop criteria have been satisfied,
causing the sampling to be stopped.

9. The method of claim 6, the method further comprising:
receiving, by the machine learning system, additional data items to at least one of the categories of the plurality of categories of data items;
respectively re-indexing, by the machine learning system, the data items, wherein the data items comprise the additional data items, of the plurality of categories of data items into updated respective indexes; and
re-sampling, by the machine learning system, the data items, wherein the data items comprise the additional data items, according to the target distribution and the stop criteria using the updated respective indexes.

10. The method of claim 6, the method further comprising:
receiving additional data items to at least one of the categories of the plurality of categories of data items;
responsive to receiving the additional data items,
adding the additional data items to the data items being sampled;
adding overwrite criteria to the stop criteria, wherein the overwrite criteria launch a continuation of the sampling; and
in response to the determining that the stop criteria have been satisfied, launching the continuation of the sampling.

11. The method of claim 10, the method further comprising:
responsive to receiving an indication that the reception of the additional data items to the at least one category of the plurality of categories of data items,
causing the overwrite criteria to be removed from the stop criteria.

12. The method of claim 6, wherein the stop criteria comprise an indication that a largest category of data items of the plurality of categories of data items has been fully sampled.

13. The method of claim 6, wherein the sampling, by the machine learning system,
the data items from the respective categories of data items comprises:
determining that at least one index of the respective indexes has been fully sampled; and
shuffling the at least one index.

14. The method of claim 6, the method further comprising:
responsive to receiving an indication that the target distribution has been updated,
updating the stop criteria, wherein the stop criteria comprise at least an indication of convergence to the updated target distribution.

15. The method of claim 14, the method further comprising:
responsive to updating the stop criteria,
sampling, by the machine learning system, the data items from the respective categories of data items according to the updated target distribution and the updated stop criteria using the respective indexes.

16. One or more non-transitory, computer-readable storage media, storing program instructions that when executed on or across one or more computing devices cause the one or more computing devices to:
identify, by a machine learning system, a target distribution of categorical source data comprising a plurality of categories of data items, wherein:
the categorical source data has an initial distribution of the data items within the plurality of categories; and
the target distribution is different from the initial distribution;
respectively index data items of the plurality of categories of data items into respective indexes;
determine stop criteria for generating the target distribution;
sample the data items from the respective categories of data items according to the target distribution and the stop criteria using the respective indexes;
determine that the stop criteria have been satisfied; and
store the target distribution of categorical source data in a target location.

17. The one or more non-transitory, computer-readable storage media of claim 16 storing further program instructions that when executed on or across the one or more computing devices further cause the one or more computing devices to:
responsive to receiving an indication that the target distribution has been updated,
update the stop criteria, wherein the stop criteria comprise at least an indication of convergence to the updated target distribution; and
sample the data items from the respective categories of data items according to the updated target distribution and the updated stop criteria using the respective indexes.

18. The one or more non-transitory, computer-readable storage media of claim 16, storing further program instructions that when executed on or across the one or more computing devices further cause the one or more computing devices to:
responsive to respectively indexing, by the machine learning system, the data items of the plurality of categories of data items into the respective indexes,
shuffle the respective indexes.

19. The one or more non-transitory, computer-readable storage media of claim 16, storing further program instructions that when executed on or across the one or more computing devices further cause the one or more computing devices to:
responsive to determining that the stop criteria have been satisfied,
cause the sampling to be stopped.

20. The one or more non-transitory, computer-readable storage media of claim 16, storing further program instructions that when executed on or across the one or more computing devices further cause the one or more computing devices to:
determine a largest index of the respective indexes; and
responsive to determining that the stop criteria have been satisfied, wherein the stop criteria indicate that the largest index has been completely sampled,
cause the sampling to be stopped.
